(19) United States
(12) Patent Application Publication
(10) Pub. No.: US 2009/0022858 A1
(43) Pub. Date: Jan. 22, 2009

(54) Food product and cooking apparatus

(76) Inventor: Adam Pawlick, Omaha, NE (US)

Correspondence Address: SUITER SWANTZ PC LLO, 14301 FNB PARKWAY, SUITE 220, OMAHA, NE, 68154, US

(21) Appl. No.: 11/880,458

(22) Filed: Jul. 20, 2007

(51) Int. Cl. B65D 81/34; A47J 27/00; A47J 36/16

(52) U.S. Cl. 426/113; 220/573.1; 220/573.4

(57) ABSTRACT

A cooking apparatus facilitates the cooking of different foodstuffs while maintaining the separateness of at least one foodstuff and another foodstuff by utilizing a at least two cooking bags. A food product that utilizes the cooking apparatus and foodstuffs produces cooked food that may be plateable.

### BACKGROUND

As contemporary society progresses, people spend less time preparing and consuming meals. Fast food, such as food provided by drive-thru chain restaurants, provides one option for those who want their meal ready for consumption in a short time; however, many people do not desire fast food or cannot eat it, due to its poor nutritional value and in particular, its high calorie, salt, and fat content.

Prepared foods, such as those appearing in supermarkets, take-out establishments, and the like, while appearing to be home cooked, are typically expensive. Additionally, like fast food, many of these prepared foods lack nutritional value, and are usually high in calories, salt, and fat. Accordingly, both fast food and prepared foods do not appeal to many consumers.

Consumers have found some suitability in frozen meals and prepackaged meals, such as those that can be heated in a microwave oven; however, these frozen meals are typically provided with mixed contents. Accordingly, when cooked or reheated, some of the contents may be undercooked, while some of the contents may be overcooked. Similarly, room temperature prepackaged meals may suffer partial degradation and discoloration of the components while in storage, and when heated in a microwave oven, the components may cook unevenly.

Typically, shelf stable, frozen, and/or refrigerated food products have a variety of undesirable attributes. Food products may combine differing types of foodstuffs (e.g., starches, sauces, proteins, vegetables, and/or fruits) together for manufacturing, processing, and/or cooking. However, different types of foodstuffs require different preparation, freezing, processing, and/or cooking times. Over-processing foodstuffs may cause negative effects on color, flavor, and texture. Therefore, these current food products have low quality flavor and undesirable organoleptic properties, such as producing a stew like mixture.

Further, shelf stable, frozen, and/or refrigerated food products typically utilize a tray format, which creates a lot of waste. Moreover, products that are dual ovenable and utilized\ a plastic tray, such as a Crystalline Polyethylene Terephthalate (CPET) tray, may have problems maintaining a hermetic seal.

Consumers desire tasty, high quality, convenient, and economical meals and snacks that are plateable. Plateability allows the consumer to choose between different food items that are cooked separately and then provided to the consumer for plating. Moreover, plateability allows the food items to be plated in a visually appealing manner. Plateability also allows the consumer to decide how healthy or unhealthy to make his or her meal. When serving gravy some individuals may want the gravy on the side for dipping, some may want the gravy on top of their food items, and others may not want gravy at all. A meal that is plateable allows an individual to decide how to serve the food items and/or sauces to his or her liking and allows consumers such as families and the commercial food service industry to provide these choices to individuals, even when serving more than one person.

Therefore, it would be desirable to provide cookable packaged food products that are high in quality, plateable, convenient, and economical, as well as a cooking apparatus for making such a food product, and a method of providing such a food product.

### SUMMARY

Accordingly, the disclosure is directed to a cooking apparatus and a food product. The cooking apparatus is comprised of a plurality of cooking bags that facilitate the cooking of different foodstuffs while maintaining the separateness thereof.

The cooking apparatus may be utilized in a microwave oven, a conventional oven, a convection oven, a combination oven, a steamer, and/or a pan of boiling water. The cooking apparatus may be comprised of a combination of nylon, EVOH, polyofins, polyesters, or metalized polymer films and may be in any suitable size or shape. The cooking apparatus may include an exterior bag and may have various configurations, such as foldable, stand up, or baking pan shaped. The cooking bag and/or the exterior bag may utilize compartments, liquid directors, perforations, vents, valves and/or opening means, such as resealable opening means.

The food product utilizes the cooking apparatus and foodstuffs to produce a meal, a portion of a meat, or a snack. The food product may also comprise a package. The food product may be configured for an individual, a family, and/or the commercial food service industry. The foodstuff may comprise a protein, a starch, a fruit, a vegetable, and/or a sauce. The food product may also comprise spices, seasonings, steam flavorings, and garnishes. The consumer may personalize the food product by hydrating a partially hydrated or dehydrated sauce with a desired liquid.

It is to be understood that both the foregoing general description and the following detailed description are exemplary and explanatory only. The accompanying drawings, which are incorporated in and constitute a part of the specification, illustrate examples and together with the general description, serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is an isometric view illustrating a food product, wherein meat, vegetables, and a second cooking bag containing sauce are contained within a first cooking bag;

FIG. 2 is an isometric view illustrating a food product, wherein meat, vegetables, and a second cooking bag containing spaghetti and a third cooking bag containing sauce are contained in a first cooking bag;

FIG. 3 is a partial cut-away isometric view illustrating a food product, wherein a mesh first cooking bag containing meat and vegetables, a laser perforated second cooking bag containing rice, and a third cooking bag containing sauce are contained in within an exterior bag;

FIG. 4 is an isometric view illustrating a food product, wherein a meat and a second cooking bag containing vegetables and a third cooking bag containing pasta and a fourth cooking bag containing sauce are contained in a first cooking bag;

FIG. 5 is a cross-sectional view of the food product illustrated in FIG. 4 taken along line 5;

FIG. 6 is an isometric view illustrating a food product that is foldable, wherein a first cooking bag contains meat, vegetables, and a second cooking bag containing sauce and pasta is contained within a third cooking bag;

FIG. 7 is an isometric view of the foldable food product as illustrated in FIG. 6, wherein the foldable food product is shown in an unfolded position;

FIG. 8 is an isometric view illustrating a food product that is foldable, wherein a perforated second cooking bag containing vegetables and a partially hydrated sauce are contained within a first cooking bag and a third cooking bag has a first compartment containing meat and a second compartment containing pasta;

FIG. 9 is an isometric view illustrating a foldable food product that has compartments, wherein a first compartment containing meat and a second compartment containing potatoes is contained in a first cooking bag and a third compartment containing vegetables and a fourth compartment containing sauce is contained in a second cooking bag;

FIG. 10 is an isometric view illustrating a food product, wherein a second cooking bag has a first compartment containing water glazed vegetables that is divided from a second compartment containing sauce by a water permeable divider and meat is contained in a first cooking bag;

FIG. 11 is an isometric view illustrating a food product, wherein an exterior bag contains a mesh first cooking bag including meat, vegetables, and a second cooking bag that includes sauce and the exterior bag also contains a laser perforated third cooking bag containing rice;

FIG. 12 is an isometric view illustrating a food product, wherein a first resealable cooking bag contains dehydrated sauce, a second resealable mesh cooking bag containing meat and vegetables, and a third resealable laser perforated cooking bag containing rice;

FIG. 13 is an isometric view illustrating a cooking apparatus, wherein a second cooking bag containing a dissolvable third cooking bag, and a first cooking bag are contained within an exterior bag; and

FIG. 14 is an isometric view illustrating a food product with a package, wherein meat, vegetables, and a second frangible cooking bag containing sauce are contained in a first cooking bag.

### DETAILED DESCRIPTION

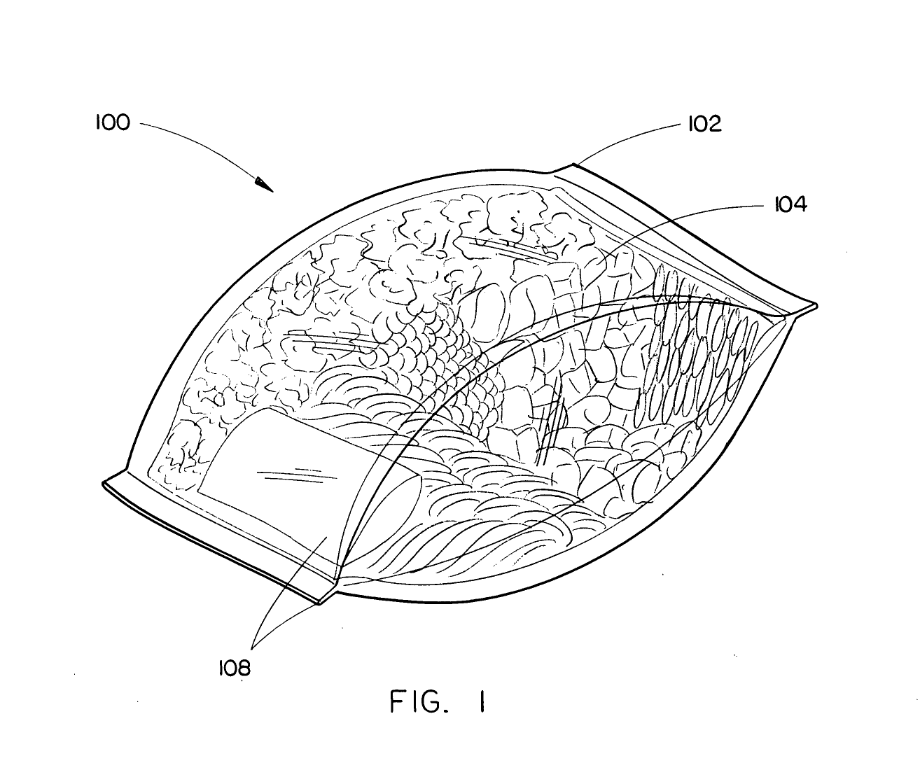

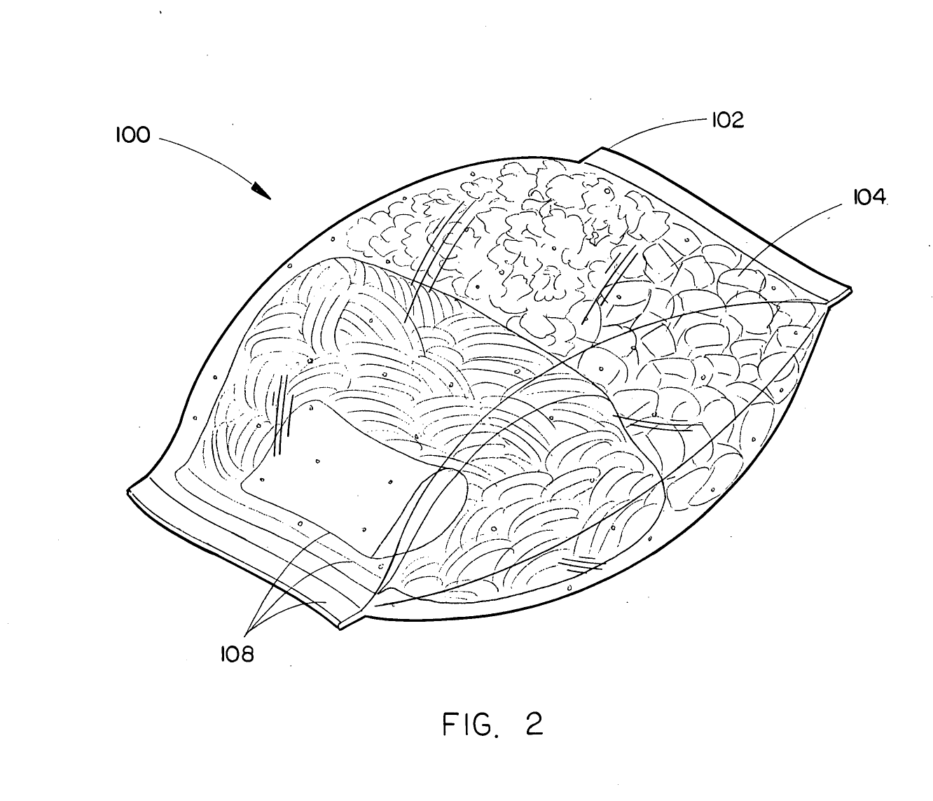

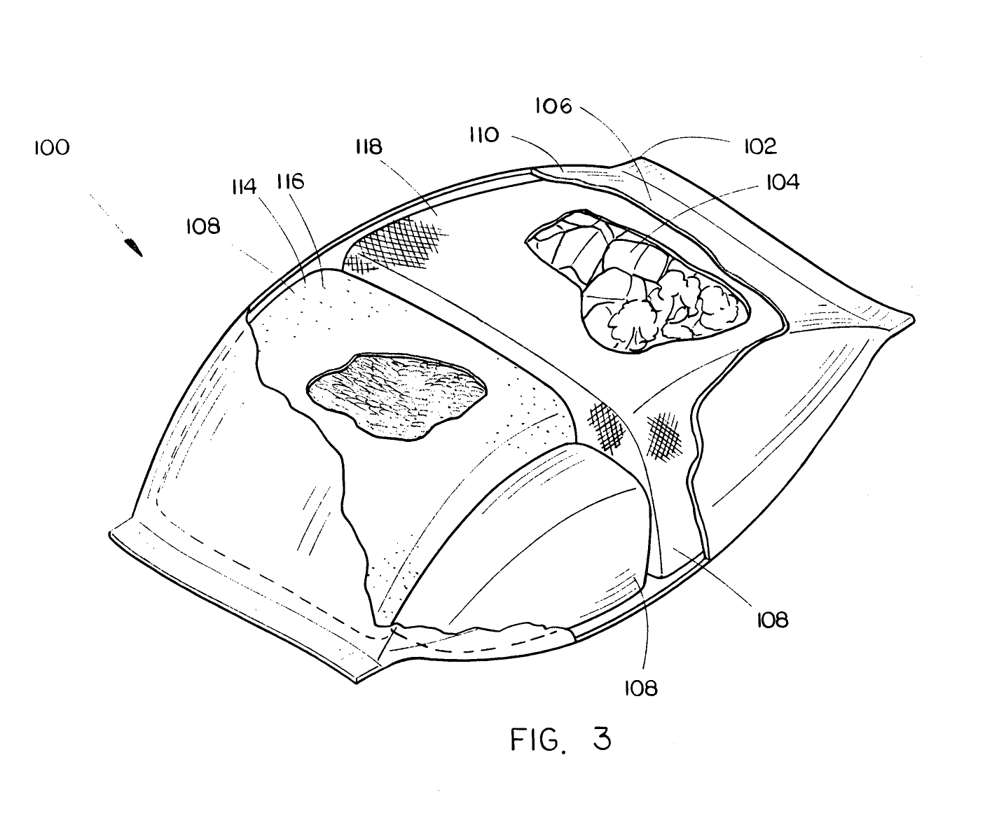

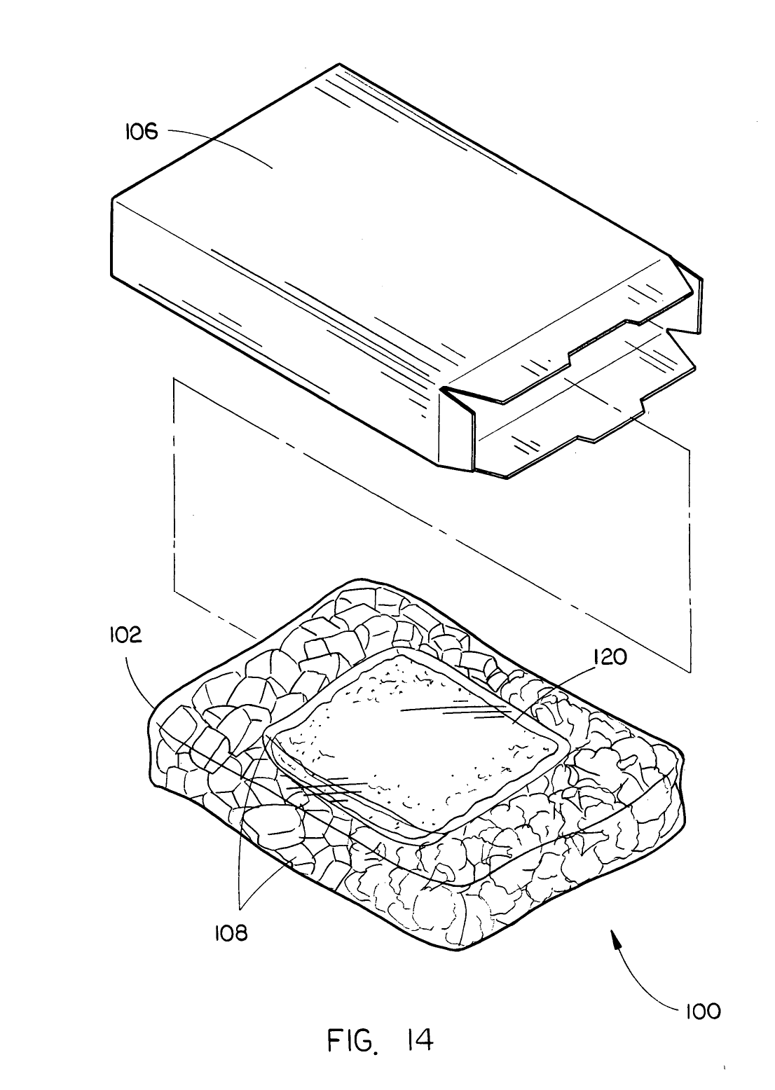

Referring generally to FIGS. 1 through 12 and 14, a food product 100 is shown. The food product 100 may be a frozen, refrigerated, or shelf stable food product. The food product may be stored at temperatures ranging from ambient temperatures to freezing temperatures depending upon the application. The food product 100 comprises a cooking apparatus 102 and a foodstuff 104. The food product 100 may further comprise a package 106 as illustrated in FIGS. 3 and 14. The cooking apparatus, as illustrated in FIG. 3, may comprise an exterior bag 110, such as a package 106, while the cooking apparatus, as illustrated in FIG. 14, is removed from the package 106 before cooking. It will be appreciated that a variety of packages may be utilized with the food product 100.

Referring now to FIG. 13, a cooking apparatus 102 is shown. The cooking apparatus 102 has separate cooking bags 108 for foodstuffs, such that the separateness and integrity of each foodstuff is maintained from processing (filling, freezing, manufacturing, and packaging) through storage and/or cooking. The cooking apparatus 102 is designed for holding the foodstuffs to maintain the separateness and integrity of each foodstuff during storage and/or cooking. The different foodstuffs may be combined after cooking. The cooking apparatus 102 is for cooking the foodstuff in the cooking apparatus to substantially contemporaneous completion. The foodstuff may be steam cooked by the cooking apparatus. The foodstuff may comprise sauces, starches, proteins, fruits, and/or vegetables. This list is exemplary only and is not meant to be restrictive. It is contemplated that a variety of edible products may be utilized without departing from the scope and spirit of the disclosure.

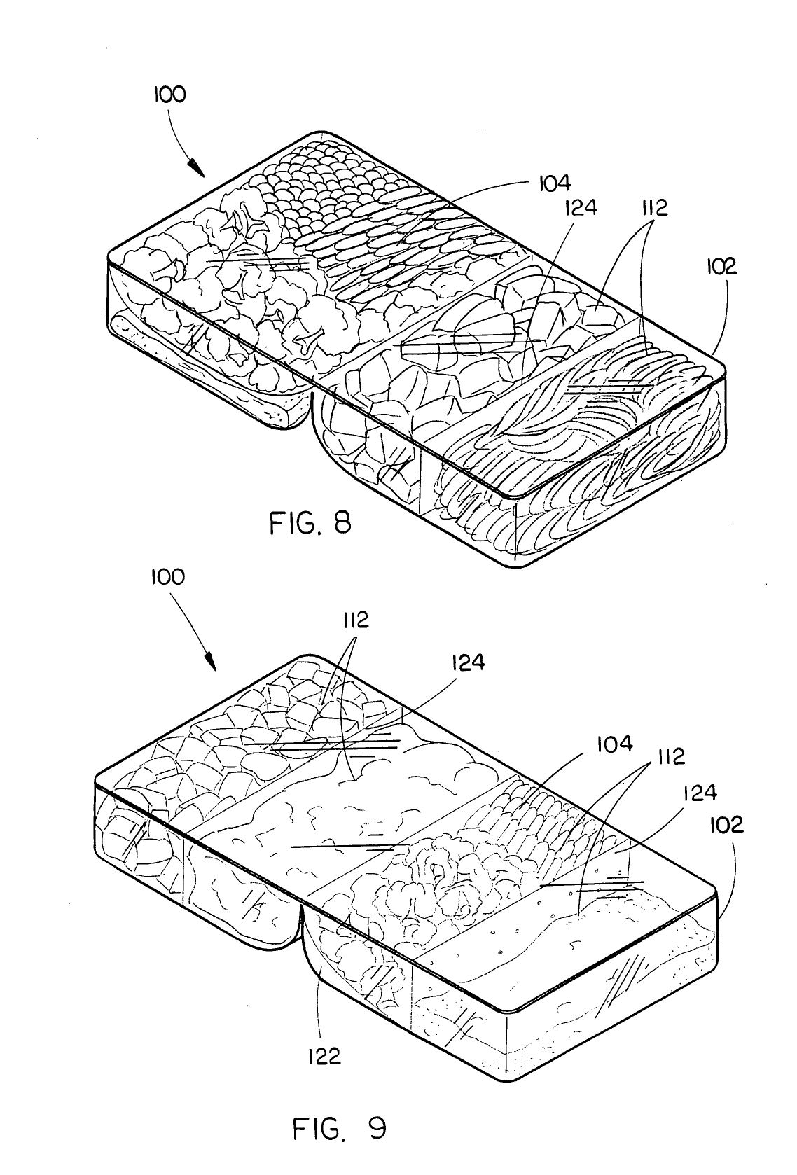

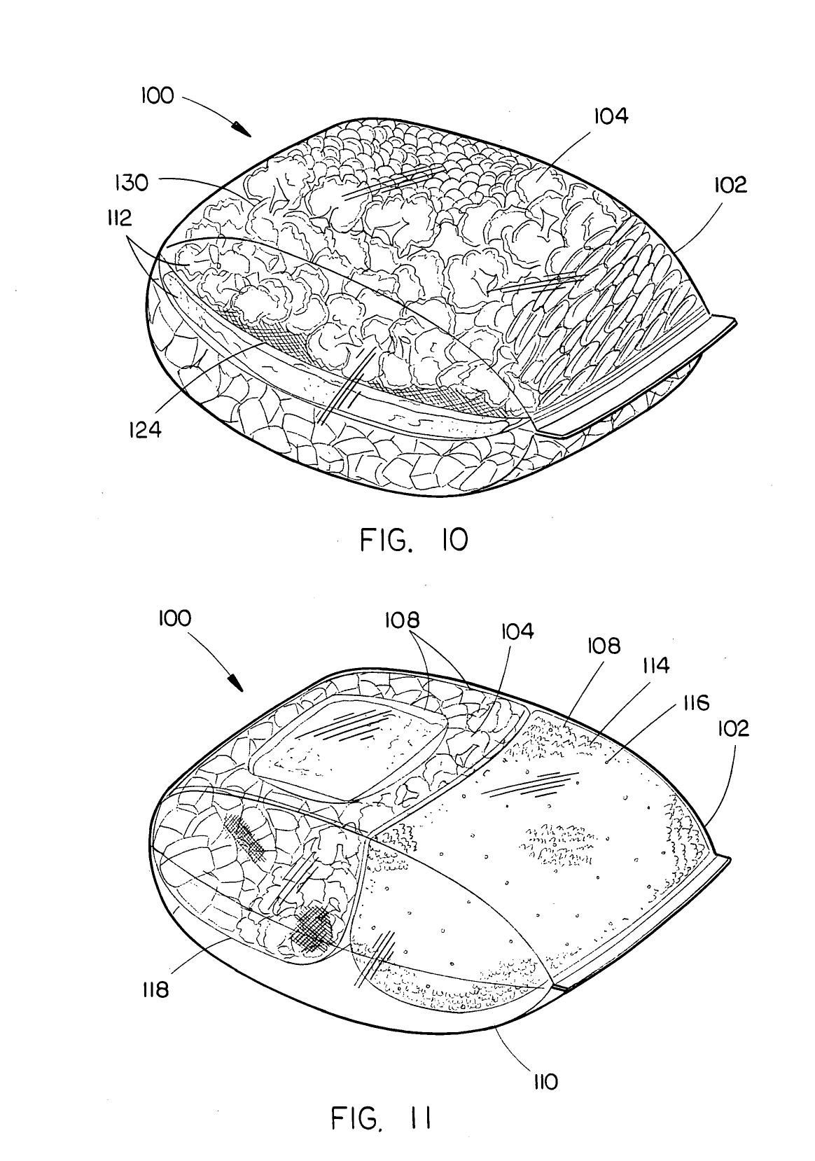

The cooking apparatus 102 comprises at least two cooking bags 108. The cooking apparatus 102 may comprise an exterior bag 110 as illustrated in FIGS. 13 and 11. The exterior bag 110 surrounds a cooking bag 108. The exterior bag 110 does not contain foodstuff 104, unless the foodstuff 104 is contained in a cooking bag 108. At least one of the cooking bags 108 is contained within another cooking bag 108 or an exterior bag 110. The cooking bag 108 contained within the cooking bag 108 contains another cooking bag 108 and this cooking bag 108 may contain another cooking bag 108 or an interior cooking bag 108, as illustrated in FIG. 5. The cooking bag 108 may contain compartments 112 as illustrated in FIGS. 8 through 10. The compartments are separated by a divider 124. The divider may be liquid and/or air impermeable or permeable. A compartment may have a liquid director 122 to direct excreted liquid into another compartment as illustrated in FIG. 9. The liquid director may help the sauce to maintain or reach a certain viscosity and/or prevents foodstuffs from getting soggy by remaining or seeping in the foodstuffs' own moisture excreted during cooking. The exterior bag 110 or the cooking bag 108 may comprise liquid absorbing material or material coated with a moisture absorbing coating, such as polypropylene, foam based materials, and paper based materials to prevent foodstuffs from getting soggy.

The food product 100 may be vacuum packed or filled with other suitable inert gasses, such as CO₂, N₂, CO, O₂, or blends thereof. Because oxygen may cause oxidation and/or degradation of the foodstuffs, removing oxygen from the food product 100 may prevent this interaction and increase the shelf-life of the food product 100.

Because the cooking apparatus 102 is solely comprised of bags, the cooking apparatus 102 may be more environmentally friendly than many other cooking apparatuses. Further, the sole utilization of bags may create less waste than solid molded cooking apparatuses, and may provide the consumer with the perception of a more environmentally friendly packaging option. As used herein, a consumer is defined as an individual, a family, and/or the food service industry. Moreover, the cooking bags may be reusable or recyclable creating less waste and an environmentally friendly product.

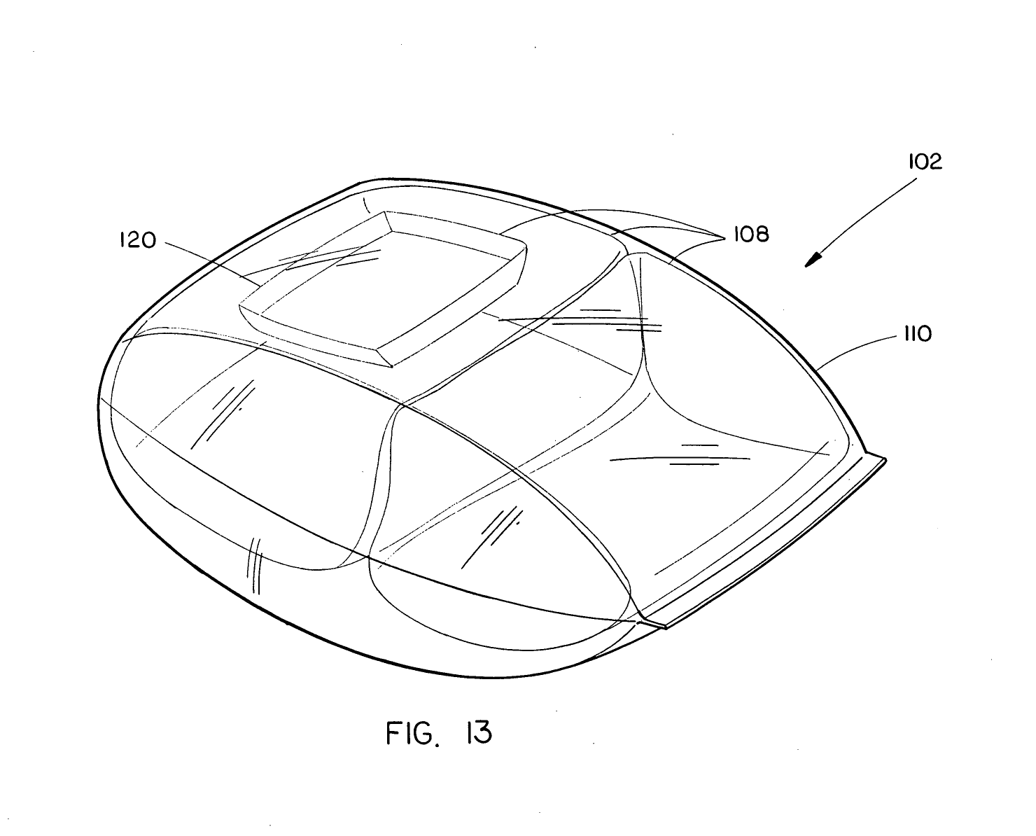

The cooking apparatus 102, the exterior bag 110, and the cooking bags 108 may be opened with a designed opening means, with scissors, and/or by applying a reasonable amount of force. The cooking apparatus 102, the exterior bag 110, and the cooking bags 108 may have numerous opening means. The cooking apparatus 102, the exterior bag 110, and the cooking bags 108 may comprise a resealable opening means 126 as illustrated in FIG. 12. The cooking bag may be opened for the addition of liquid to hydrate the partially dehydrated sauce or dehydrated sauce prior to cooking.

The cooking apparatus 102, the exterior bag 110, and the cooking bags 108 may comprise opening means such as a partial tear beginning, a line or strip pulling means, a weakened portion, a frangible opening mechanism, a dissolving opening mechanism, a rip seal, a complementary tooth and grove system, or a zipper seal. This list is exemplary only and is not meant to be restrictive. It is contemplated that a variety of suitable opening means and resealable opening means 126 that are capable of staying resealed through cooking may be utilized without departing form the scope and intent of the disclosure.

The resealable opening means may change color to indicate that the cooking bag 108 is completely sealed or closed. The cooking bag 108 may open during cooking 120 by utilizing a frangible opening means or a dissolvable (or edible) cooking bag, as illustrated in FIG. 14. The dissolvable cooking bag 108 may dissolve during cooking. The cooking bag 108 may be edible and completely dissolve upon heating to release the content of the cooking bag 108 after a certain amount of heat is applied to the cooking apparatus 102. The dissolvable material may be comprised of any currently available food safe edible material. If the cooking bag 108 is frangible, the cooking bag 108 may be designed to rupture after a certain amount of pressure is obtained inside the cooking bag 108.

The cooking apparatus 102, the exterior bag 110, and the cooking bag 108 may be formed in any shape, configuration, or size in order to accommodate an individual, a family, and/or the commercial food service industry. The cooking apparatus 102, the exterior bag 110, and the cooking bags 108 may be of any general shape without departing from the scope of the disclosure. Suitable shapes may include circular, oval, rectangular, and square, among others.

The cooking bag 108 and/or the exterior bag 110 may contain perforations 114 as illustrated in FIGS. 3, 11, and 12. A portion of the cooking bag 108 and/or the exterior bag 110 may be perforated. The bag may be a laser perforated film 116 as illustrated in FIGS. 3, 11, and 12. Perforations 114 may be utilized for steaming foodstuffs 104 as an additional cooking mechanism. Foodstuff that is steam cooked may be essentially self basting. The perforations 114 may be utilized as openings for drainage. The cooking bag 108 may be a mesh bag 118 as illustrated in FIGS. 3, 11, and 12. The mesh bag as described in the U.S. Provisional Patent Application No. 60/845,786 may be utilized and is herein incorporated by reference.

The cooking bag 108 and/or the exterior bag 110 may be vented or contain a valve. The vents or the valves may be one-way or two-way valves or vents. A cooking bag and/or exterior bag may rupture after about two to three minutes providing partial pressure cooking and partial vented cooking. The cooking bag may be designed to rupture after the cooking bag reaches a certain amount of pressure. Self-venting and pressurization films marketed under the trade names of “Dream Steam” produced by Creative New Food located at Wasterkingerweg, CH-8193 Eglisau and “Steam Fast” produced by Excelsior Packaging Group Inc. located at 159 Alexander St., Yonkers N.Y. 10701 may be utilized.

The cooking apparatus 102 may be utilized in a microwave oven, a conventional oven, a convection oven, a combination oven, and/or a steamer to cook foodstuffs 104 contained within the cooking bags 108. The cooking apparatus 102 may be cooked in a pan of boiling water or by the steam produced by a pan of boiling water. The material of the cooking bag 108 may be comprised of nylon, EVOH, polyofins, polyesters, and/or metalized polymer films.

When a nylon cooking bag is utilized, the cooking bag may have one or more of the following properties:
Heat deflection temperature (66 psi): at least 400° F.
Heat deflection temperature (264 psi): at least 160° F.
Melting point: at least 420° F.
Elongation fail percentage: 150-170%

Such properties may enable the nylon cooking bag 108 to expand to a certain degree under heating while maintaining its structural integrity and avoiding rupture. This allows the nylon cooking bag 108 to maintain a seated, non-venting environment in which the temperature and pressure can be increased during the cooking process. Such capabilities may provide for the pressure cooking of foodstuffs 104. Because the boiling point of water increases as the surrounding air pressure increases, the pressure built up inside the nylon cooking bag 108 allows the liquid in the packaging to rise to a temperature higher than 212° F. before boiling. Most commercial pressure cookers have an internal pressure setting of 15. At this pressure water boils at 257° F. The various configurations may permit pressures of up to and in excess of commercial pressure cookers. These higher temperatures resulting from the increased pressure cause the foodstuff 104 to cook faster thereby reducing cooking times and resulting in a cooked product having increased moisture content and reduced thermal degradation. The nylon cooking bag as describe in the U.S. Non-Provisional application Ser. No. 11/636,260 may be utilized and is herein incorporated by reference.

The amount of pressure and/or steam generated within the nylon cooking bag may be controlled by varying the thickness of the nylon, the free water content of the foodstuffs 104 and/or the residual air permitted to remain within the cooking bag 108 following a vacuum sealing process. The ability to adjust these variables allows for controlling of the cooking environment such that it is particularly suited to a given type of foodstuff 104 or type of food components 104.

Moreover, steam generated inside of the nylon cooking bag condenses immediately to water as soon as the bag is removed from the heating apparatus. When a nylon cooking bag is opened after cooking, the risk of steam exposure to the consumer may be minimized. Therefore, the nylon cooking bag may be more practical than currently utilized cooking bags.

Depending upon the foodstuff utilized, materials may vary per cooking bag in one cooking apparatus for cooking the differing foodstuffs to substantially contemporaneous completion. One bag may be heat reflective and another cooking bag may utilize pressure for cooking. The thickness of the cooking bag material may be increased or decreased to finish cooking varying foodstuffs at the same time. The cooking bags may be insulated, vacuumed packed, arranged in a specific configuration, or nitrogen (or other suitable inert gas or combination of inert gases) flushed to finish cooking varying foodstuffs at the same time. The cooking apparatus may additionally contain microwave focusing and/or shielding technology to provide simultaneous cooking of differing food items. All of these techniques may be utilized individually or in combination to finish cooking varying foodstuffs at the same time. In another combination the cooking apparatus may include any self-venting technology that will allow it to regulate the internal pressure.

The cooking apparatus may be configured in several different ways to provide different desired meals or snacks. The varying configurations are designed to provide convenient or fast, easy, and simple separations of the foodstuffs 104 contained in separate cooking bags. The most convenient configuration may be different for the individual consumer versus the commercial food service industry.

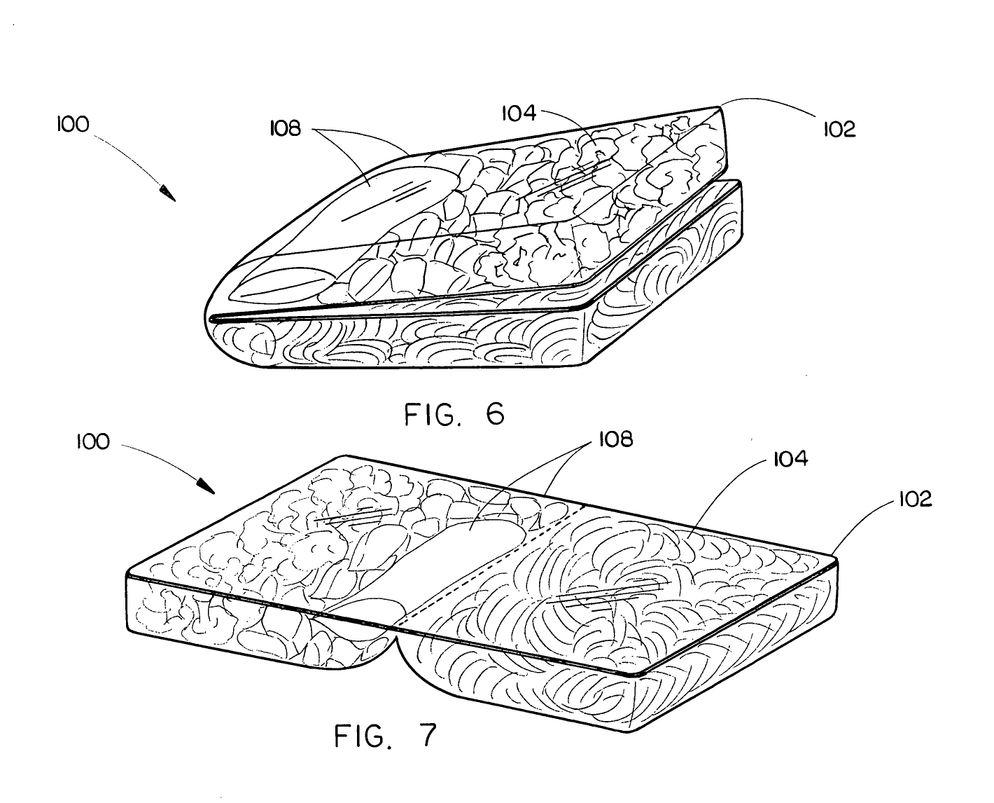

The cooking apparatus including the exterior bag and/or the cooking bag may be foldable or fold out, as illustrated in FIGS. 6, 7, 8, and 9. The cooking apparatus may be configured to stand up, as illustrated in FIG. 12.

The cooking bags may be configured to provide a preferred drainage direction by attaching a cooking bag to the top of another cooking bag or exterior bag as illustrated in FIGS. 8 and 10 through 14. The top of the cooking bag is the side of the cooking bag opposite the side that abuts the ground, table, or heating apparatus (e.g., microwave oven or conventional oven) or the side labeled as the top or opposite the side labeled as the bottom.

The cooking bag may imitate the shape of a baking pan as illustrated in FIG. 14. The cooking bags that imitate a baking pan configuration and the foldable cooking apparatus are particularly well suited for the food service industry.

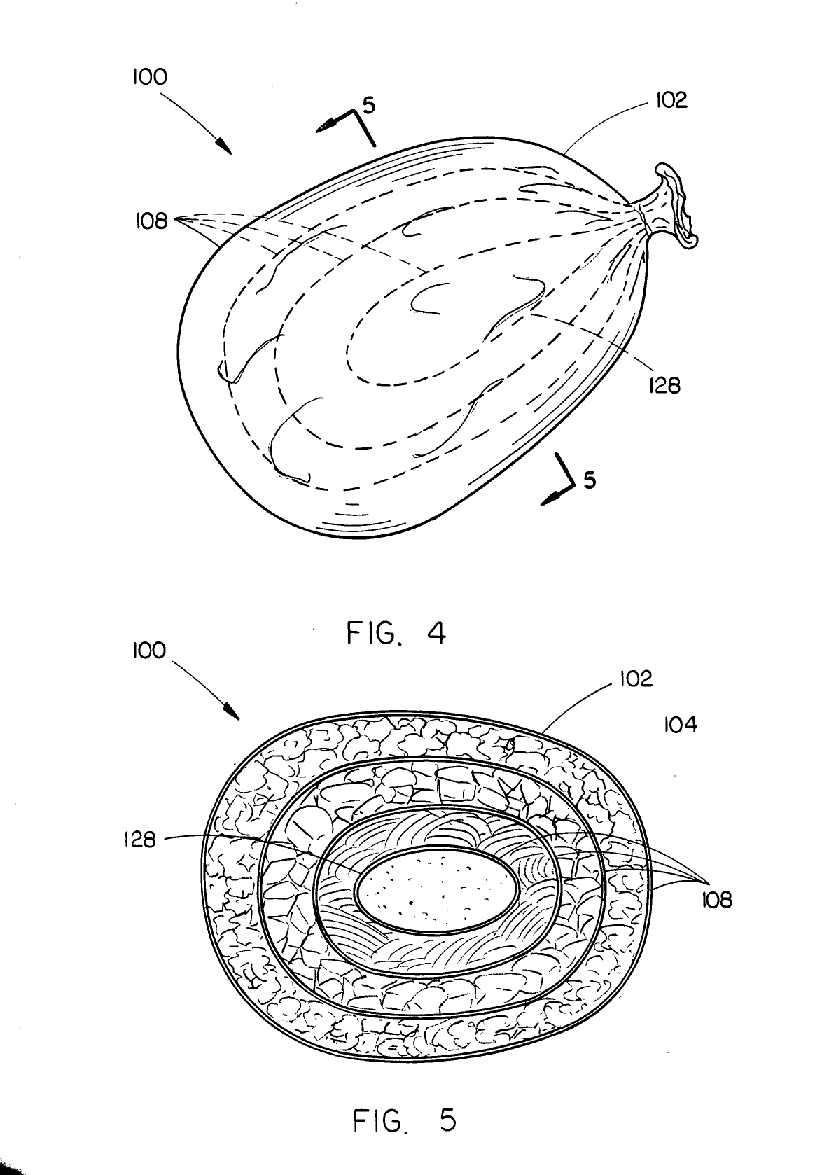

The cooking apparatus 100 may be configured to insulate interior cooking bags or cooking bags contained within other cooking bags with foodstuffs as illustrated in FIGS. 4 and 5. These interior cooking bags or cooking bags contained within other cooking bags may not reach the same high temperature as cooking bags closer to the exterior of the cooking apparatus; therefore, this configuration may allow for the utilization of different lower melt-point bag materials that are cheaper and easier to shape. The material of the insulated cooking bag 128 may comprise nylon; Polyethylene Terepthalate (PET); PP; EVOH; polyeurathane; formed, opened, or closed cellulose structures; or combinations, blends or laminations thereof.

The different types of foodstuff 104 or food components 104, sauces, liquids, starches, proteins, fruits, and/or vegetables, may be utilized in varying combinations and forms. A fruit and/or vegetable comprise any edible portion of a plant. Typically, a fruit is any edible seed bearing part of the plant and a vegetable is any edible non-seed bearing part of the plant. Fruits may comprise apples, apricots, avocado, bananas, strawberries, blueberries, raspberries, cherries, grapefruit, grapes, kiwi fruit, lemons, limes, mangoes, nectarines, oranges, peaches, pears, papaya, pineapple, plums, prunes, raisins, tangerines, cantaloupe, honeydew, and watermelon. Further, vegetables may comprise bok choy, broccoli, collard greens, dark green leafy lettuce, kale, mesclun, mustard greens, romaine lettuce, spinach, turnip greens, watercress, acorn, squash, butternut squash, carrots, hubbard squash, pumpkin, sweet potatoes, black beans, black-eyed peas, garbanzo beans (chickpeas), kidney beans, lentils, lima beans (mature), navy beans, pinto beans, soy beans, split peas, tofu (bean curd made from soybeans), white beans, corn, green peas, lima beans (green), peanuts, potatoes, artichokes, asparagus, bean sprouts, beets, brussel sprouts, cabbage, cauliflower, celery, cucumbers, eggplant, green beans, green or red peppers, iceberg (head) lettuce, mushrooms, okra, onions, parsnips, tomatoes, turnips, wax beans, and zucchini. It will be appreciated that this list is not exhaustive and is not meant to be restrictive. Thus, other fruits and vegetables may be utilized without departing from scope and spirit of the disclosure.

Only one type of fruit or one type of vegetable may be utilized. If varying types of fruits and/or vegetables are utilized in the food product 100, they may be cooked in separate cooking bags 108 or together in one cooking bag 108 to substantially contemporaneous completion.

The food product 100 may utilize proteins. Proteins may comprise any ingestible tissue of mammals, birds, reptiles, or fish. A protein therefore includes, but is not limited to, tissue derived from cattle, porcine, poultry, ruminant (e.g. bison, and deer), and fish sources. If varying types of protein are utilized in the food product 100, they may be cooked in separate cooking bags 108 or together in one cooking bag 108 to substantially contemporaneous completion.

The food product 100 may utilize starches. Starches may comprise any foodstuff that is made with flour, such as breads (leavened or unleavened), or any foodstuffs that have high concentrations of complex carbohydrates that are insoluble in water, such as pastas, potatoes, and rice. If varying types of starches are utilized in the food product 100, they may be cooked in separate cooking bags 108 or together in one cooking bag 108 to substantially contemporaneous completion. It is contemplated that certain foodstuffs 104 may be applicable to more than one of the listed types of foodstuffs 104, such as potatoes, which may be classified as a vegetable or a starch and sauce, which may be classified as a sauce and a liquid.

The food product 100 may utilize a sauce. Typically, consumers find the utilization of sauce in a food product as ascetically pleasing. The sauce may be contained in a stand up cooking bag. Moreover, the sauce may add water vapor to the cooking process and create convection current during heating to decrease the cook time for the particulates.

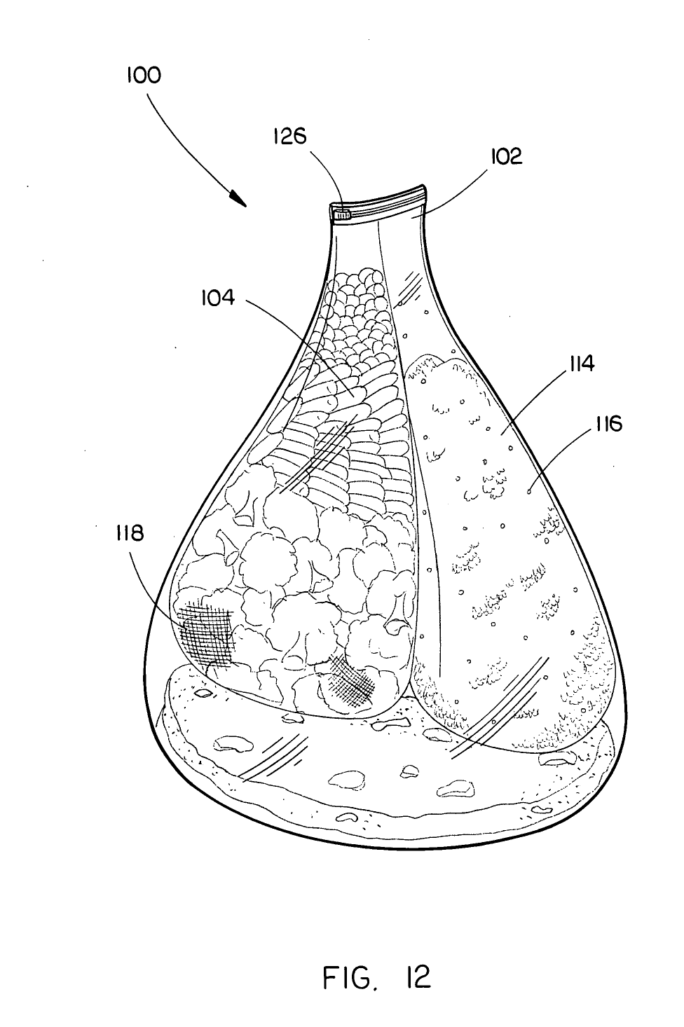

The sauce may be in multiple forms. The sauce may be hydrated, partially hydrated, or dehydrated. The dehydrated sauce may be held together by binders, such as gums, starches, and/or any other suitable binders know by those skilled in the art. Hydrated sauce may be frozen in one large block or in multiple smaller blocks. The frozen sauce may be granulated, chunked, shaved, cubed, or chipped. A nitrogen filled roller may be utilized to freeze the sauce into a thin sheet that is chipped and put into the cooking apparatus 102. The frozen sauce may be contained in a compartment 112 of a cooking bag 108, as illustrated in FIGS. 9 and 10, in its own cooking bag 108, as illustrated in FIG. 1, or in a cooking bag 108 that opens upon cooking 120, as illustrated in FIG. 14.

The sauce may be partially hydrated in the form of a paste, a concentrate, or a get. The sauce may be dehydrated in the form of a matrix, leather, or powder. The dehydrated sauce includes a dry mix of ingredients that may be hydrated to form a sauce. The liquid may be added prior to or after cooking in order fully or partially hydrate the sauce. A consumer may control the thickness/viscosity of a sauce by controlling the amount of liquid added to a partially hydrated or dehydrated sauce.

The liquid may be included in the food product 100 as a frozen block of ice, in a separate cooking bag 108 or in an exterior bag 110. When the liquid is contained in a separate cooking bag 108, the cooking bag may be frangible or made of an edible dissolvable material to release the liquid into the partially hydrated or dehydrated sauce during cooking. The liquid may be any edible liquid, such as a dairy based liquid (i.e., milk or cream), an alcoholic beverage (i.e., beer or wine), a meat stock, a meat broth, an oil, a soda, sauce, water, or juice. This list is exemplary only and is not meant to be restrictive. It is contemplated that a variety of edible liquids may be utilized without departing from the scope and spirit of the disclosure.

The liquid may be added by the consumer. The liquid may be added directly to the cooking bag 108 containing the partially hydrated or dehydrated sauce. The liquid is poured through a perforated cooking bag 108 over other foodstuffs 104, such as fruits and/or vegetables to drain into the cooking bag containing the partially hydrated or dehydrated sauce. When foodstuffs 104 are frozen, pouring liquid over them to hydrate the sauce helps to defrost the frozen foodstuffs 104, lowering cooking time for a more convenient and better tasting product. The added liquid may be warm or boiling. The cooking bags 108 are opened for pouring in liquid and then resealed with a resealable opening means 126, as illustrated in FIG. 12.

The partially hydrated or the dehydrated sauce may comprise a foundational blend that allows the consumer to add his or her own ingredients or liquids to customize the sauce to his or her individual tastes or allows the customer to follow a myriad of different sets of recipes provided with the food product. The sauce may be able to change from a red sauce to a white sauce for different pasta dishes based on a consumer added ingredient or a choice of ingredients found with the food product 100.

Water may be obtained during cooking from the moisture contained in other foodstuffs 104 as illustrated in FIGS. 8, 9, 10, and 12. When foodstuffs 104 such as fruits and/or vegetables cook, they may excrete water and this excreted water may be directed to hydrate the partially hydrated or dehydrated sauce. The foodstuffs 104 such as fruits and/or vegetables may be coated with a water glaze 130 that melts from the foodstuffs 104 upon heating and is directed to hydrate the partially hydrated or dehydrated sauce as illustrated in FIG. 10. In addition to hydrating the sauce, the water glaze may protect the flavor of foodstuffs 104 during processing, cooking, and storing. Further, Nutrients that leech out of the foodstuffs 104 with the water during cooking may be recaptured in the sauce to maintain the nutrients of the food product 100.

Because foodstuffs 104 may excrete water when cooked, the sauces should be formulated to account for various changes in moisture that may occur during cooking, based on the packaging configuration. The sauces' moisture content may be formulated to produce optimal viscosity after cooking.

Several benefits are associated with the utilization of a partially hydrated or dehydrated sauce. The cost of adding the liquid is saved. Further, because less liquid is contained in the food product 100, the overall weight of the food product 100 is reduced decreasing the cost of shipping the food product 100. Third, if the food product 100 is frozen, the utilization of dry sauce will decrease cooking time because the sauce will not need to be thawed making the product more convenient. Fourth, if the food product 100 is frozen, the sauce will not have to be selected from sauces with lower freezing points to prevent the sauce from thawing prematurely and creeping/drifting/flowing into unintended areas. Fifth, partially hydrated and fully hydrated sauces may not need to be precooked; therefore, the sauce will be fresher and taste better when the sauce is cooked for the first time by the consumer.

The sauce may be separated from all of the other types of foodstuffs 104 or types of food components 104. There are several advantages to separating the sauce. First, if vegetables and/or fruits are part of the food product 100, the vegetables and/or fruits do not need to be blast frozen. Typically, if the sauce is on the fruits and/or vegetables, the fruits and/or vegetables are individually quick frozen (IQF), the sauce is poured onto the fruits and/or vegetables, and the combination is blast frozen. Because the sauce may be frozen separate from the fruits and/or vegetables, the fruits and/or vegetables are only IQF with no need for blast freezing. Additionally, a four day hold period that is typically associated with the blast freezing of fruits and/or vegetables and sauce is eliminated by sauce separation. The elimination of blast freezing also prevents the cells in the fruits and/or vegetables from being overly strained and damaged during the freezing and thawing caused by the application of sauce to IQF fruits and/or vegetables prior to blast freezing. This creates a better resulting texture and/or flavor in the fruits and/or vegetables. Therefore, the food product 100 may be produced more efficiently by eliminating the four day hold period and is produced with higher quality taste by maintaining the integrity of cell structures over products that do not separate sauce from fruits and/or vegetables in a prepackaged product. Further, when the sauce is heated and the sauce contacts other foodstuffs, the heated sauce may damage and/or degrade the other foodstuffs. The separation of the sauce prevents contact between the sauce and the other foodstuffs to prevent damage to the other foodstuffs.

The food product 100 may contain a separate cooking bag containing seasonings or a separate packet of seasonings to allow the food service industry, a family, or an individual to decide how much, if any, seasoning (e.g., salt) is desired in a given snack or meal. Seasonings may be withheld by a consumer to increase the healthly characteristics of the meal. The seasoning may be immersed in a liquid during cooking to provide specific flavors and aromas to foodstuffs cooked by the liquid's steam. These steam flavoring formulations may be provided in the liquid, in a frangible or dissolvable cooking bag, in cheese cloth, or in another suitable containment structure. If the steam flavoring formulations are in a separate cooking bag or packet, the consumer can choose to include or exclude the flavoring. Moreover, the steam flavoring formulations may be applied to a portion of the meat or to the whole meat based on the configuration of the utilized cooking apparatus 102. Water combined with the steam flavoring formulations may be utilized to cook the vegetables, while steam from a sauce may be utilized to cook a meat or starch. The steam flavoring formulations may comprise Sachet D'epices (i.e., three to four parsley stems, one sprig thyme, one bay leaf, and one teaspoon of cracked peppercorns in one gallon of liquid); Bouquet Garni (i.e., one sprig thyme, three to four parsley stems, one bay leaf, and two to three leek leaves or one celery stalk cut crosswise in half in one gallon of liquid); and/or Onion Pique (i.e., one-fourth of a peeled onion sliced half way down to its center to hold a bay leaf and three whole cloves.

The food product 100 may contain a garnish. A garnish is an edible food or drink that is added to a dish, meat, or snack for decoration. Typically, the garnish is configured or cut to be visually pleasing (e.g., in the shape of a flower or an animal). The garnish may be removed before cooking or cooked. The garnish may be contained in a cooking bag if cooked. A garnish may comprise herbs, seasonings, fruits, and/or vegetables. This list is exemplary only and is not meant to be restrictive. It is contemplated that a variety of edible products may be utilized without departing from the scope and intent of the disclosure.

In general, differing foodstuffs may be contained in separate bags. However, foodstuffs of differing types may be combined in one cooking bag 108. The sauce may contain particulates of other types of foodstuffs, such as protein, fruits, and/or vegetables. The sauce may protect the particulates from freezer burn, but may increase the cooking time of the food product 100. The particulate may be contained in separate cooking bag. The cooking bag may be edible and/or frangible and release the particulates into the sauce during cooking, or the consumer may choose to remove the particulates from or add the particulates to the sauce.

The cooking bag 108, such as a mesh bag 118, may contain protein and a fruit and/or a vegetable. Starches and fruits and/or vegetables may be contained in the same cooking bag 108, such as tomatoes, potatoes, and green beans. At least one foodstuff may be separated from at least another foodstuff during processing, storing, or cooking.

The capacity of cooking apparatus may be adjusted to provide for an individual, a family, and/or the commercial food service industry. A cooking apparatus 102 may comprise serving sizes from 6 oz. to 96 oz. Furthermore, the food product 100 may be distributed in several ways. A case of varying meals or a case of the same individually sized meal may be compiled and sold. Varying numbers of different individual sized meals may be sold to accommodate families of different numbers. The consumer may be able to select the combination of different individually sized meals, meat components, or ingredient combinations through a counter with a person (such as a kiosk), by ordering on-line, or via a vending machine. The meals may be designed to accommodate children, adults, and/or specific dietary constraints, such as weight loss and heart healthy needs. The food product 100 may include plates, utensils, and/or napkins for consumers who plan on consuming their meal away from home, such as at the office.

The foodstuffs 104 of the food product 100 may be selected to provide a snack or meal. The foodstuffs 104 contained in the food product 100 may be selected to provide a portion of a meal, multiple portions of a meal, or a whole meal. The food product 100 may comprise an appetizer, such as nachos. The food product 100 may contain a plurality of different appetizers, such as potato skins, buffalo wings, mozzarella sticks, and onion rings. The food product 100 may contain a plurality of different side items, such as rice, beans, vegetables, and grits. The food product 100 may contain a dessert or a plurality of different desserts. This list is exemplary only and is not meant to be restrictive. It is understood that a variety of edible products may be utilized without departing from the scope and intent of the disclosure.

The cooking apparatus and food product provides numerous advantages over the prior art by separating the different types of foodstuffs 104 or food components 104. This separation leads to significant improvements in food quality, including improvements in texture, hold life, color, and flavor.

The separate cooking produces a food product that may be plateable. Plateability allows the consumer to choose between different food items and/or sauces that are cooked simultaneously. Therefore, an individual may plate, assemble, and customize their meal according to his or her preferences and tastes. Moreover, plateability allows food to be placed on a plate or tray in different visually appealing configurations. Further, if an individual is allowed to plate his or her own meal, the food product 100 allows each individual to sort out unhealthy items if desired.

The cooking apparatus 102 provides several thermodynamic advantages in cooking by separating the different types of foodstuffs 104 to create a more appetizing and higher quality food product. Separating the foodstuff increases the surface area of the foodstuffs by total volume. The increased surface area increases the surface area to which heat may be transferred resulting in greater efficiency in cooking. Further, the thickness of the food is decreased, allowing for shorter cooking times and more even cooking.

Moreover, the density of the foodstuff 104 is decreased allowing the heating apparatus (e.g., microwave oven or convection oven) greater access to the center of the foodstuffs 104 for better and faster cooking times. Additionally, the foodstuffs 104 are not as densely packed, allowing the foodstuffs 104 to be more effectively heated with better heat transfer also helping to shorten cooking times. Typically, the less cooking time utilized, the less heat degradation of the food product.

Furthermore, the cooking bags 108 may be compartmentalized to allow foodstuffs that require more heat to cook, to receive more heat and foodstuffs that require less heat to cook, to receive less heat to prevent undercooking and/or overcooking of the foodstuffs by insulating the foodstuffs that require less heat with other foodstuffs that require more heat, as illustrated in FIGS. 4 and 5.

The cooking apparatus 102 provides several storage advantages by separating the different types of foodstuffs to produce a more appetizing and higher quality food product. The separation of foodstuffs 104 may help to prevent degradation and discoloration during storage from the interaction of differing types of foodstuffs. Further, separation of foodstuff in multiple cooking bags may help to prevent freezer burn when the food product 100 is stored in a freezer.

The cooking apparatus 102 provides several processing advantages by separating the different types of foodstuffs to produce a more appetizing and higher quality food product. The separate cooking bags allow different types of foodstuffs to be manufactured, frozen, and/or processed, separately. Differing types of foodstuffs may require different processing, such as filling, manufacturing, and freezing, while extra processing may have negative effects on the quality of the foodstuffs by effecting texture, color, and the flavor of foodstuffs. Therefore, by separating the differing types of foodstuffs, each type of foodstuff may get the exact amount of processing required producing a better tasting and higher quality food product.

Separation of the different types of foodstuffs also provides enhanced control of the moisture levels and ultimately, the quality of the food ingredients. Individually quick frozen (IQF) foods may be placed in the perforated bag separated from other food ingredients. As the IQF foods thaw, moisture can drain from the perforated bag and into an exterior bag 110 or another cooking bag 108 as illustrated in FIGS. 8, 10, 11, and 12. This keeps the IQF foods from becoming soggy by remaining or seeping in their excreted moisture, and also may ensure that the other food ingredients in the container that require moisture do not dry out.

The cooking apparatus 102 is largely compatible with existing methods of meal preparation in the foodservice industry. When all of the cooking bags 108 are nested/consolidated into one bag during packaging and cooking, there may be no need for additional oven space to prepare the meal. Further, the cooking apparatus 102 allows for the introduction of new food items into the foodservice industry. Currently, breaded items may not meet consumer standards when prepared in foodservice trays that do not provide separation of ingredients. By placing breaded items into a separate cooking bag 108 of the cooking apparatus 102, they may come out crispy instead of soggy. This will open up a plethora of new food items for the foodservice industry without excessive changes to current methods.

The separation of the different types of foodstuffs also provides decreased freeze times for food products 100 that are freezer stored. The reduced density and increased surface area of the foodstuffs provided by the separation of the different types of foodstuffs makes the foodstuffs freeze faster. The decrease in freeze time reduces over processing and increases the efficiency of producing the product. An increase of efficiency reduces the cost of making the freezer stored food product 100.

It is believed that the disclosure and many of its attendant advantages will be understood by the foregoing description, and it will be apparent that various changes may be made in the form, construction and arrangement of the components thereof without departing from the scope and spirit of the disclosure or without sacrificing all of its material advantages. The form herein before described being merely an explanatory, it is the intention of the following claims to encompass and include such changes.

What is claimed is:

1. A cooking apparatus, comprising:
a first cooking bag for containing a first foodstuff; and
a second cooking bag for containing a second foodstuff, the second cooking bag contained in the first cooking bag,
wherein the first cooking bag and the second cooking bag maintain the separateness of the first foodstuff and the second foodstuff during cooking, and
wherein the first cooking bag and the second cooking bag are for cooking the first foodstuff and the second foodstuff to substantially contemporaneous completion.

2. The cooking apparatus as claimed in claim 1, further comprising an exterior bag for containing the first cooking bag and the second cooking bag.

3. The cooking apparatus as claimed in claim 1, wherein at least one of the first cooking bag and the second cooking bag are for steam cooking.

4. The cooking apparatus as claimed in claim 1, wherein at least one of the first cooking bag and the second cooking bag are for pressure cooking.

5. The cooking apparatus as claimed in claim 1, wherein at least one of the first cooking bag and the second cooking bag has perforations.

6. The cooking apparatus as claimed in claim 1, wherein a portion of at least one of the first cooking bag and the second cooking bag has perforations.

7. The cooking apparatus as claimed in claim 1, wherein at least one of the first cooking bag and the second cooking bag comprises a mesh bag.

8. The cooking apparatus as claimed in claim 1, wherein the first cooking bag and the second cooking bag are at least one of ovenable, microwaveable, steamable, and boilable.

9. The cooking apparatus as claimed in claim 1, wherein the first cooking bag and the second cooking bag are capable of storing at least one of the first foodstuff and the second foodstuff selected from the group of a shelf stable foodstuff, a refrigerated foodstuff, and a frozen foodstuff.

10. The cooking apparatus as claimed in claim 1, wherein the first cooking bag and the second cooking bag maintain the separateness of the first foodstuff and the second foodstuff during storage and processing.

11. The cooking apparatus as claimed in claim 1, wherein at least one of the first cooking bag and the second cooking bag comprises an opening means.

12. A food product, comprising:
a first cooking bag;
a second cooking bag contained within the first cooking bag;
a first foodstuff contained within the first cooking bag; and
a second foodstuff contained within the second cooking bag,
wherein the first cooking bag and the second cooking bag maintain the separateness of the first foodstuff and the second foodstuff during cooking, and
wherein the first cooking bag and the second cooking bag are for cooking the first foodstuff and the second foodstuff to substantially contemporaneous completion.

13. The food product as claimed in claim 12, further comprising an exterior bag for containing the first cooking bag and the second cooking bag.

14. The food product as claimed in claim 12, wherein at least one of the first foodstuff and the second foodstuff is steam cooked.

15. The food product as claimed in claim 12, wherein at least one of the first foodstuff and the second foodstuff is pressure cooked.

16. The food product as claimed in claim 12, wherein at least one of the first cooking bag and the second cooking bag has perforations.

17. The food product as claimed in claim 12, wherein a portion of at least one of the first cooking bag and the second cooking bag has perforations.

18. The food product as claimed in claim 12, wherein at least one of the first cooking bag and the second cooking bag comprises a mesh bag.

19. The food product as claimed in claim 12, wherein the first cooking bag, the second cooking bag, the first foodstuff, and the second foodstuff are at least one of ovenable, microwaveable, steamable, and boilable.

20. The food product as claimed in claim 12, wherein the first foodstuff and the second foodstuff are selected from the group of shelf stable foodstuffs, refrigerated foodstuffs, and frozen foodstuffs.

21. The food product as claimed in claim 12, wherein the first cooking bag and the second cooking bag maintain the separateness of the first foodstuff and the second foodstuff during storage and processing.

22. The food product as claimed in claim 12, wherein at least one of the first cooking bag and the second cooking bag comprises an opening means.

23. A cooking apparatus, comprising:
a cooking bag for containing a foodstuff; and
at least two associated cooking bags for containing associated foodstuffs, the at Least two associated cooking bags contained in the cooking bag,
wherein the separateness of at least one of the foodstuff and the associated foodstuffs and another one of the foodstuff and the associated foodstuffs is maintained during cooking, and
wherein the cooking bag and the at Least two associated cooking bags are for cooking the foodstuff and the associated foodstuffs to substantially contemporaneous completion.

24. The cooking apparatus as claimed in claim 23, further comprising an exterior bag for containing the cooking bag and the at Least two associated cooking bags.

25. The cooking apparatus as claimed in claim 23, wherein at least one of the cooking bag and the at least two associated cooking bags are for steam cooking.

26. The cooking apparatus as claimed in claim 23, wherein at least one of the cooking bag and the at least two associated cooking bags are for pressure cooking.

27. The cooking apparatus as claimed in claim 23, wherein at least one of the cooking bag and the at least two associated cooking bags has at least one of perforations, valves, and compartments.

28. The cooking apparatus as claimed in claim 23, wherein a portion of at least one of the cooking bag and the at least two associated cooking bags has perforations.

29. The cooking apparatus as claimed in claim 23, wherein at least one of the cooking bag and the at least two associated cooking bags comprises a mesh bag.

30. The cooking apparatus as claimed in claim 23, wherein the cooking bag and the at least two associated bags are at least one of ovenable, microwaveable, steamable, and boilable.

31. The cooking apparatus as claimed in claim 23, wherein the cooking bag and the at least two associated cooking bags are capable of storing the foodstuff and associated foodstuffs selected from the group of shelf stable foodstuff, refrigerated foodstuff, and frozen foodstuff.

32. The cooking apparatus as claimed in claim 23, wherein the cooking bag and the at least two associated cooking bags maintain the separateness of at least one of the foodstuff and the associated foodstuffs from another one of the foodstuff and the associated foodstuffs during storage and processing.

33. The cooking apparatus as claimed in claim 23, wherein at least one of the cooking bag and the at least two associated cooking bags comprises an opening means.

34. The cooking apparatus as claimed in claim 23, wherein at least one of the at least two associated cooking bags is contained within at least one of another of the at least two associated cooking bags.

35. The cooking apparatus as claimed in claim 34, wherein the at least one of the at least two associated cooking bags contained within the at least one of another of the at least two associated cooking bags contains an interior cooking bag.

36. The cooking apparatus as claimed in claim 35, wherein at least one of the at least two associated cooking bags contained within the at least one of another of the at least two associated cooking bags and the interior cooking bag is insulated with at least one of the foodstuff and the associated foodstuffs.

37. The cooking apparatus as claimed in claim 23, wherein at least one of the cooking bag and the at least two associated cooking bags is at least one of dissolvable, frangible, rupturable, liquid absorbable, and foldable.

38. A food product, comprising:
a cooking bag;
at least two associated cooking bags contained within the cooking bag;
a foodstuff contained within the cooking bag; and
associated foodstuffs contained within the at least two associated cooking bags,
wherein the separateness of at least one of the foodstuff and the associated foodstuffs and another one of the foodstuff and the associated foodstuffs is maintained during cooking, and
wherein the cooking bag and the at least two associated cooking bags are for cooking the foodstuff and the associated foodstuffs to substantially contemporaneous completion.

39. The food product as claimed in claim 38, further comprising an exterior bag for containing the cooking bag and the at least two associated cooking bags.

40. The food product as claimed in claim 38, wherein at least one of the foodstuff and the at least two foodstuffs is steam cooked.

41. The food product as claimed in claim 38, wherein at least one of the foodstuff and the at least two foodstuffs is pressure cooked.

42. The food product as claimed in claim 38, wherein at least one of the cooking bag and the at least two associated cooking bags has at least one of perforations, valves, and compartments.

43. The food product as claimed in claim 38, wherein a portion of at least one of the cooking bag and the at least two associated cooking bags has perforations.

44. The food product as claimed in claim 38, wherein at least one of the cooking bag and the at least two associated cooking bags comprises a mesh bag.

45. The food product as claimed in claim 38, wherein the cooking bag and the at least two associated bags are at least one of ovenable, microwaveable, steamable, and boilable.

46. The food product as claimed in claim 38, wherein the foodstuff and the associated foodstuffs are selected from a group of shelf stable foodstuff, refrigerated foodstuff, and frozen foodstuff.

47. The food product as claimed in claim 38, wherein the separateness of at least one of the foodstuff and the associated foodstuffs and another one of the foodstuff and the associated foodstuffs is maintained during storage and processing.

48. The food product as claimed in claim 38, wherein at least one of the cooking bag and the at least two associated cooking bags comprises an opening means.

49. The food product as claimed in claim 48, wherein the at least one of the at least two associated cooking bags is contained within at least one of another of the at least two associated cooking bags.

50. The food product as claimed in claim 49, wherein the at least one of the at least two associated cooking bags contained within at least one of another of the at least two associated cooking bags contains an interior cooking bag.

51. The food product as claimed in claim 49, wherein at least one of the cooking bag and the at least two associated cooking bags is at least one of dissolvable, frangible, rupturable, liquid absorbable, and foldable.

52. The food product as claimed in claim 50, wherein the at least one of the at least two associated cooking bags contained within the at least one of another of the at least two associated cooking bags and the interior cooking bag is insulated with at least one of the foodstuff and the associated foodstuffs.

53. The food product as claimed in claim 38, wherein the foodstuff and the associated foodstuffs comprise at least one starch, protein, vegetable, fruit, seasoning, garnish, sauce, and liquid.

54. The food product as claimed in claim 53, wherein the dehydrated or the partially dehydrated sauce are reconstituted by at least one of liquid from a vegetable water glaze, liquid excreted from cooking the foodstuff and the at least two associated foodstuffs, frozen liquid within the same cooking bag, liquid contained within a different cooking bag, liquid contained within an exterior bag, and liquid poured through at least one cooking bag.

55. The food product as claimed in claim 53, wherein the dehydrated sauce and the partially dehydrated sauce comprise a foundational blend.

56. The food product as claimed in claim 52, wherein the sauce is at least one of a hydrated sauce, a dehydrated sauce, and a partially dehydrated sauce.

57. The food product as claimed in claim 52, wherein the seasoning is contained in the liquid and seasons at least one of the foodstuff and the associated foodstuffs through steam cooking.

58. A cooking apparatus, comprising:
an exterior bag; and
at least two cooking bags for containing at least two foodstuffs, the at least two cooking bags contained in the exterior bag,
wherein the separateness of at least one of the at least two foodstuffs and another one of the at least two foodstuffs is maintained during cooking, and
wherein the at least two cooking bags are for cooking the at least two foodstuffs to substantially contemporaneous completion.

59. The cooking apparatus as claimed in claim 57, wherein at least one of the at least two cooking bags is for steam cooking.

60. The cooking apparatus as claimed in claim 57, wherein at least one of the at least two cooking bags is for pressure cooking.

61. The cooking apparatus as claimed in claim 57, wherein at least one of the at least two cooking bags has at least one of perforations, valves, and compartments.

62. The cooking apparatus as claimed in claim 57, wherein the exterior bag has at least one of perforations and valves.

63. The cooking apparatus as claimed in claim 57, wherein a portion of at least one of the cooking bag and the at least two associated cooking bags has perforations.

64. The cooking apparatus as claimed in claim 57, wherein a portion of the exterior bag has perforations.

65. The cooking apparatus as claimed in claim 57, wherein at least one of the at least two cooking bags comprises a mesh bag.

66. The cooking apparatus as claimed in claim 57, wherein the at least two cooking bags are at least one of ovenable, microwaveable, steamable, and boilable.

67. The cooking apparatus as claimed in claim 57, wherein the at least two cooking bags and the exterior bag are capable of storing the at least two foodstuffs selected from a group of shelf stable foodstuffs, refrigerated foodstuffs, and frozen foodstuffs.

68. The cooking apparatus as claimed in claim 57, wherein the separateness of at least one of the at least two foodstuffs and another one of the at least two foodstuffs is maintained during storage and processing.

69. The cooking apparatus as claimed in claim 57, wherein at least one of the at least two cooking bags comprises an opening means.

70. The cooking apparatus as claimed in claim 57, wherein the exterior bag comprises an opening means.

71. The cooking apparatus as claimed in claim 57, wherein at least one of the at least two cooking bags is at least one of dissolvable, frangible, rupturable, liquid absorbable, and foldable.

72. The cooking apparatus as claimed in claim 57, wherein the exterior bag is at least one of frangible, rupturable, liquid absorbable, and foldable.

73. A food product, comprising:
an exterior bag;
at least two cooking bags contained within the exterior bag; and
at least two foodstuffs contained within the at least two cooking bags,
wherein the separateness of at least one of the at least two foodstuffs and another one of the at least two foodstuffs is maintained during cooking, and
wherein the at least two cooking bags are for cooking the at least two foodstuffs to substantially contemporaneous completion.

74. The food product as claimed in claim 72, wherein at least one of the at least two foodstuffs is steam cooked.

75. The food product as claimed in claim 72, wherein at least one of the at least two foodstuffs is pressure cooked.

76. The food product as claimed in claim 72, wherein at least one of the at least two cooking bags has at least one of perforations, valves, and compartments.

77. The food product as claimed in claim 72, wherein the exterior bag has at least one of perforations and valves.

78. The food product as claimed in claim 72, wherein a portion of at least one of the cooking bag and the at least two associated cooking bags has perforations.

79. The food product as claimed in claim 72, wherein a portion of the exterior bag has perforations.

80. The food product as claimed in claim 72, wherein at least one of the at least two cooking bags comprises a mesh bag.

81. The food product as claimed in claim 72, wherein the at least two cooking bags are at least one of ovenable, microwaveable, steamable, and boilable.

82. The food product as claimed in claim 72, wherein the at least two foodstuffs are selected from a group of shelf stable foodstuff, refrigerated foodstuff, and frozen foodstuff.

83. The food product as claimed in claim 72, wherein the separateness of at least one of the at least two foodstuffs and another one of the at least two foodstuffs is maintained during storage and processing.

84. The food product as claimed in claim 72, wherein at least one of the at least two cooking bags comprises an opening means.

85. The food product as claimed in claim 72, wherein the exterior bag comprises an opening means.

86. The food product as claimed in claim 72, wherein at least one of the at least two cooking bags is at least one of dissolvable, frangible, rupturable, liquid absorbable, and foldable.

87. The food product as claimed in claim 72, wherein the exterior bag is at least one of frangible, rupturable, liquid absorbable, and foldable.

88. The food product as claimed in claim 72, wherein the at least two foodstuffs comprise at least one starch, protein, vegetable, fruit, seasoning, garnish, sauce, and liquid.

89. The food product as claimed in claim 87, wherein the seasoning is contained in the liquid and seasons at least one of the at least two foodstuffs through steam cooking.

90. The food product as claimed in claim 87, wherein the sauce is at least one of a hydrated sauce, a dehydrated sauce, and a partially dehydrated sauce.

91. The food product as claimed in claim 89, wherein the dehydrated sauce and the partially dehydrated sauce are reconstituted by at least one of liquid from a vegetable water glaze, liquid excreted from cooking the at least two foodstuffs, frozen liquid within the same cooking bag, liquid contained within a different cooking bag, liquid contained within the exterior bag, and liquid poured through at least one cooking bag.

92. The food product as claimed in claim 89, wherein the dehydrated sauce or the partially dehydrated sauce comprises a foundational blend.
